(19) United States
(12) Patent Application Publication
(10) Pub. No.: US 2026/0239396 A1
(43) Pub. Date: Aug. 13, 2026

(54) FIRST USER EQUIPMENT, NETWORK NODE, RADIO NETWORK NODE, AND METHODS THEREIN, IN A WIRELESS COMMUNICATIONS NETWORK

(71) Applicant: Telefonaktiebolaget LM Ericsson (publ), Stockholm (SE)

(72) Inventors: Ali NADER, Malmö (SE); Martin VAN DER ZEE, Malmö (SE); Paul SCHLIWA-BERTLING, Ljungsbro (SE); Henrik ENBUSKE, Stockholm (SE)

(73) Assignee: Telefonaktiebolaget LM Ericsson (publ), Stockholm (SE)

(21) Appl. No.: 19/156,647

(22) PCT Filed: Feb. 16, 2024
(86) PCT No.: PCT/EP2024/053997

§ 371 Date: Aug. 14, 2025

Related U.S. Application Data
(60) Provisional application No. 63/446,073, filed on Feb. 16, 2023.

(51) Int. Cl. H04W 72/30; H04W 52/02; H04W 76/27

(52) U.S. Cl. CPC H04W 72/30; H04W 52/0235; H04W 76/27

(57) ABSTRACT

A method performed by a first UE for handling a Multicast Broadcast Service (MBS) session in a wireless communications network is provided. The first UE receives (503) a second indication as transmitted by a network node (130). The second indication is indicative of a time window before an activation time and/or start time of the MBS session. Upon receiving (503) the second indication, the first UE is triggered (504) to transition to a Radio Resource Control (RRC) Connected state, by selecting a frame within the time window to use for a Physical Random Access Channel (PRACH) procedure.

### TECHNICAL FIELD

Embodiments herein relate to a first User Equipment (UE), a network node, a radio network node, and methods therein. In some aspects, they relate to handling Multicast Broadcast Service (MBS) sessions in a wireless communications network.

### BACKGROUND

In a typical wireless communications network, wireless devices, also known as wireless communication devices, mobile stations, stations (STA) and/or UEs, communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

### MBS Multicast

In Rel-17 Multicast Broadcast Service (MBS) is introduced, which enables a network to send the same data to a large group of UEs efficiently. There are two ways to convey the data: MBS broadcast and MBS multicast. MBS broadcast is supported in all Radio Resource Control states. MBS multicast is supported in RRC_CONNECTED Release-17 (Rel-17) and RRC_INACTIVE in Release 18 (Rel-18) as Radio Resource Control (RRC) states.

In case of multicast reception in RRC_INACTIVE the UE may receive a Point-to-Multipoint (PTM) configuration, e.g., an MBS Radio Bearer (MRB) configuration, already in RRC_CONNECTED or acquire this via Multicast Control Channel (MCCH) while in RRC_INACTIVE. With MBS broadcast the PTM configuration is always acquired from the MCCH.

If a UE wants to receive multicast data the UE first has to join a multicast session, e.g., see 3GPP TS 23.247 section 7.2.1.3. The UE is then authorized and the UE may receive security keys to decrypt the multicast data.

When the first UEs joins the session, this triggers a network node in the CN to create the session in RAN and provide Quality of Service (QoS) information. This enables the RAN to reserve resources, and the RAN can then configure the UE with a multicast MRB. The session is then in a de-activated state, and the RAN can decide to release the UE to RRC_IDLE or RRC_INACTIVE based on data inactivity. When the session is activated later, and multicast transmissions may start, group paging is triggered in CN for CM-IDLE UEs and in RAN for UEs in RRC_INACTIVE for the UEs to return to RRC_CONNECTED. This is illustrated in FIG. 1.

After the CN has activated the session in the RAN, downlink multicast transmissions can start. The CN can also deactivate the session, e.g. when there is no multicast data for some time. It is not known before hand when a session will be deactivated, and when a session is deactivated, the RAN does not know when the session will be activated again. For the MBS session states see e.g., 3GPP TS 23.247 section 4.1. In case a session is deactivated the RAN can decide to release the multicast UEs to RRC_IDLE or RRC_INACTIVE. When the session is activated again, the UEs will be paged and return to RRC_CONNECTED mode to continue multicast data reception. In case a session is activated the RAN may decide to release the UE to RRC_INACTIVE when there is data inactivity. When there is new data the RAN with pages the UEs in RRC_INACTIVE again.

When the multicast session is activated by the CN, the RAN will configure the UEs in RRC_CONNECTED mode with a multicast MRB to enable the UE to receive the multicast data. Typically a single MRB is configured for a multicast session, but in case multiple QoS flows are associated with the multicast session, multiple MRBs may be configured.

### eDRX and MICO Mode

A UE supporting MBS broadcast or multicast may also support Extended Discontinuous Reception (eDRX) or Mobile Initiated Connection Only (MICO) mode. eDRX and MICO mode are “negotiated” between UE and a CN network node, except for eDRX in RRC_INACTIVE which is configured by RAN, e.g., by gNB in the RAN. The negotiation means that the UE asks for eDRX or MICO mode configuration, and the network node in the CN than can configure it. The RAN is aware when the UE is configured with eDRX or MICO mode.

In RRC_IDLE the UE can be configured with an eDRX cycle length up to 10485.76 seconds (2.9 h). In RRC_INACTIVE the UE can be configured with an eDRX cycle length up to 10.24 sec, provided that the UE is configured with eDRX in RRC_IDLE.

When MICO mode is activated, in RRC_IDLE only, the UE is not required to perform (AS) activities, e.g., Radio Resource Management (RRM) measurements, to support Idle mode mobility and to ensure that the UE is always camped on the strongest/best cell. The UE is only required to wake-up and perform periodic registration. The periodic registration timer, T3512, can be configured very long General Packet Radio Service (GPRS) timer 3) i.e. up to 9920 hours~1.1 year, also referred to as a sabbatical. The CN may optionally configure an Activation Time, T3324, during which time the UE remains reachable for Paging after leaving RRC_CONNECTED e.g. after periodic registration. When MICO mode is activated, the UE is not reachable, i.e. does not monitor paging. An illustration of different stages of activated/deactivated MICO mode, and when the UE has active time for monitoring paging is illustrated in FIG. 2.

### MBS Multicast

In Rel-17 Multicast/Broadcast Service (MBS) is introduced which enables the network to send the same data to a large group of UEs efficiently. There are two ways to convey the data: MBS broadcast and MBS multicast. MBS broadcast is supported in all RRC states. MBS multicast is supported in RRC_CONNECTED (Rel-17) and RRC_INACTIVE (Rel-18).

In case of multicast reception in RRC_INACTIVE the UE may receive the PTM configuration (MRB configuration) already in RRC_CONNECTED or acquire this via MCCH while in RRC_INACTIVE. With MBS broadcast the PTM configuration is always acquired from the MCCH.

If the UE wants to receive multicast data the UE first has to join the multicast session, see TS 23.247 section 7.2.1.3. The UE is then authorized and the UE may receive security keys to decrypt the multicast data.

When the first UEs joins the session, this triggers the CN to create the session in RAN and provide QoS information. This enables the RAN to reserve resources, and the RAN can then configure the UE with a multicast MRB. The session is then in a deactivated state, and the RAN can decide to release the UE to RRC_IDLE or RRC_INACTIVE based on data inactivity. When the session is activated later, and multicast transmissions may start, group paging is triggered in CN for CM-IDLE UEs and in RAN for UEs in RRC_INACTIVE for the UEs to return to RRC_CONNECTED:

After the CN has activated the session in the RAN, downlink multicast transmissions can start. The CN can also deactivate the session, e.g. when there is no multicast data for some time. It is not known before hand when a session will be deactivated, and when a session is deactivated, the RAN does not know when the session will be activated again. For the MBS session states see 3GPP TS 23.247 section 4.1. In case a session is deactivated the RAN can decide to release the multicast UEs to RRC_IDLE or RRC_INACTIVE. When the session is activated again, the UEs will be paged and return to RRC_CONNECTED mode to continue multicast data reception. In case a session is activated the RAN may decide to release the UE to RRC_INACTIVE when there is data inactivity. When there is new data the RAN with pages the UEs in RRC_INACTIVE again.

When the multicast session is activated by the CN, the RAN will configure the UEs in RRC_CONNECTED mode with a multicast MRB to enable the UE to receive the multicast data. Typically a single MRB is configured for a multicast session, but in case multiple QoS flows are associated with the multicast session, multiple MRBs may be configured.

### eDRX and MICO Mode

A UE supporting MBS broadcast or multicast may also support eDRX or MICO mode. eDRX and MICO mode are “negotiated” between UE and the CN, except for eDRX in RRC_INACTIVE which is configured by RAN. The negotiation means that the UE asks for eDRX or MICO mode configuration, and the CN than can configure it. The RAN is aware when the UE is configured with eDRX or MICO mode.

In RRC_IDLE the UE can be configured with an eDRX cycle length up to 10485.76 seconds or 2.9 hours (h). In RRC_INACTIVE the UE can be configured with an eDRX cycle length up to 10.24 sec, provided that the UE is configured with eDRX in RRC_IDLE.

When MICO mode is activated, such as in RRC_IDLE only, the UE is not required to perform AS activities, e.g. monitoring Paging or perform measurements. The UE is only required to wake-up and perform periodic registration. The periodic registration timer, T3512, can be configured very long, GPRS timer 3, i.e. up to 9920 hours~1.1 year, aka sabbatical. The CN may optionally configure an Activation Time, T3324, during which time the UE remains reachable for Paging after leaving RRC_CONNECTED, e.g. after periodic registration. When MICO mode is activated, the UE is not reachable, i.e. does not monitor paging:

When the UE goes to RRC_CONNECTED, e.g., to send UL data, and MICO mode is activated, then MICO mode remains activated when the UE returns to RRC_IDLE until the next periodic location or mobility registration.

### Service Announcement

In Rel-17 UEs can be configured via service announcement per TMGI, i.e., a multicast session, when, e.g., a start time, and where, using a Tracking Area Identity (TAI) and/or cell list, a UE should join the session to receive multicast data.

In Rel-18 to support MBS multicast with UE power saving such as eDRX and/or MICO mode. 3GPP Service and System Aspects 2 (SA2) introduces a series of scheduled activation times, i.e. this could be a list of one or more activation times. In this case it is known in advance when the activation will happen, e.g. firmware download to RedCap UEs in eDRX or MICO mode. It is assumed that in between the scheduled activation times, the legacy “unscheduled” deactivations/activations may happen. The scheduled activation time is a date and time for example in UTC format, e.g. YYYY-MM-DD and time hh:mm:ss. The granularity is in seconds. A Simple Network Management Protocol (SNTP) time synchronization requirement for a UE using MBS sessions is also +\−1 second.

### Joining an MBS Session

A UE may join an MBS session, when in an inactive RRC state by performing a Random Access in a Random Access Channel (RACH), also referred to as RACH or RACH procedure.

The Join procedure may further be executed between a UE and a CN node, e.g., a Session Management Function (SMF), i.e. a protocol exchange runs on top (NAS protocol). The UE requests to join, the CN/SMF either accepts or rejects. For the UE to send a Join request, the UE needs to establish an RRC Connection, e.g., RRC_CONNECTED state.

For example, when a Non-Access Stratum (NAS) sends a request, e.g. to for a UE to join an MBS session, and when the UE is in RRC_IDLE, the UE may initiate access by sending a preamble in the next available Physical Random Access Channel (PRACH) occasion, e.g., as in 3GPP TS 38.321. The next available PRACH occasion depends on a PRACH configuration, e.g., as transmitted in a System Information Block (SIB), such as SIB1, e.g. comprising a PRACH configuration index referring to lookup Tables in 3GPP TS 38.211.

### SUMMARY

A problem with MBS sessions identified as part of developing embodiments herein is that when there are data to be received in a session, multiple UE's may need to transition to an RRC connected state to join the session for receiving the session data. The UEs may typically be triggered to perform these transitions simultaneously or at least over a short period of time. As the number of multiple UE's grow a consequence is that congestion increasingly becomes a problem due to conflicts in selecting PRACH occasions to use for transitioning to the connected state which may delay transitioning of the UEs due to unsuccessful random access procedures. This means that for a large number of UEs to join an MBS session may take an excessive amount of time, and UE's may risk missing data transmitted in the session.

An object of embodiments herein is to provide a more efficient handling of MBS sessions.

According to a first aspect, a method performed by a first UE for handling an MBS, session in a wireless communications network is provided. The first UE receives a second indication as transmitted by a network node. The second indication is indicative of a time window before an activation time and/or start time of the MBS session. Upon receiving the second indication, triggering the first UE to transition to an RRC Connected state, by selecting a frame within the time window to use for a PRACH procedure.

A PRACH procedure as used herein may mean any RACH procedure or other random access procedure suitable to perform, typically using one or more PRACH occasions for said random access procedure.

According to a second aspect, a method performed by a network node for handling an MBS session in a wireless communications network is provided. The network node transmits towards a first UE, a second indication indicative of a time window before an activation time and/or start time of the MBS session. The first UE is arranged to be triggered upon receiving the second indication, to transition to an RRC Connected state, by selecting a frame within the time window to use for a PRACH procedure.

According to a third aspect, a method performed by a radio network node for handling an MBS session in a wireless communications network is provided. The radio network node forwards from a network node to a first UE, a second indication indicative of a time window before an activation time, and/or start time of the MBS session.

According to a fourth aspect, a first UE configured to handle an MBS session in a wireless communications network is provided. The first UE is configured to receive a second indication as transmitted by a network node, the second indication being indicative of a time window before an activation time and/or start time of the MBS session, and upon receiving the second indication, trigger the first UE to transition to an RRC Connected state, by selecting a frame within the time window to use for a PRACH procedure.

According to a fifth aspect a network node configured to handle an MBS session in a wireless communications network is provided. The network node is configured to transmit towards a first UE, a second indication indicative of a time window before an activation time and/or start time of the MBS session. The first UE is arranged to be triggered upon receiving the second indication, to transition to an RRC Connected state, by selecting a frame within the time window to use for a PRACH, procedure.

According to a sixth aspect a radio network node configured to handle an MBS session in a wireless communications network is provided. The radio network node is configured to forward from a network node to a first UE, a second indication indicative of a time window before an activation time, and/or start time of the MBS session.

Since the first UE receives the second indication, as transmitted from the network node and forwarded from the radio network node, the first UE may select a frame within the time window indicated by the second indication for performing the PRACH procedure, i.e., random access towards the radio network node. Since the frame is selected within the time window congestion for UEs joining the MBS session can be reduced. This is since not all UEs will attempt to use the same PRACH occasion for performing the random access and thereby efficiency in handling the MBS session is improved. Furthermore, since the time window is before the activation or start of the MBS session, it is ensured that the first UE can join the MBS session before data is transmitted.

### BRIEF DESCRIPTION OF THE DRAWINGS

Examples of embodiments herein are described in more detail with reference to attached drawings in which:

FIG. 1 illustrates a sequence diagram according to prior art.

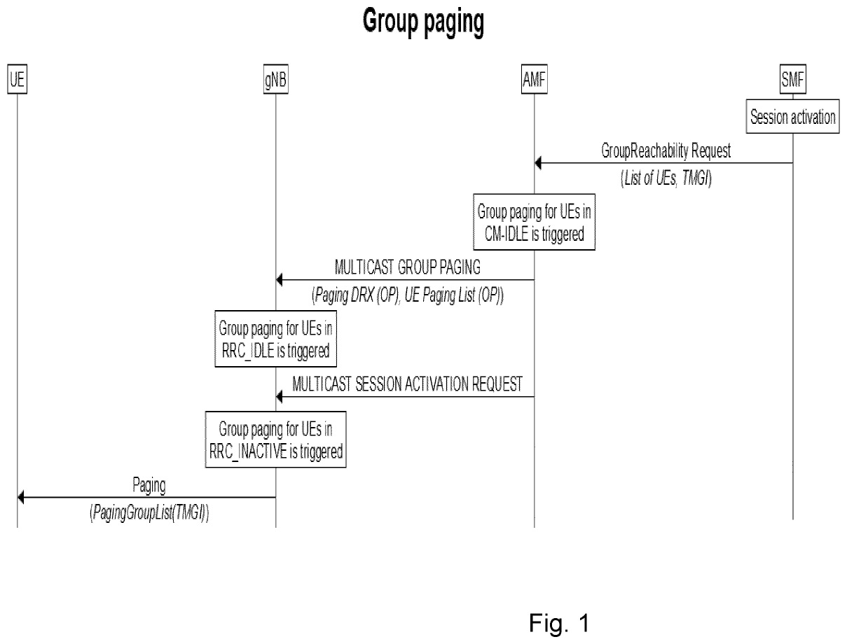

FIG. 2 illustrates MICO mode according to prior art.

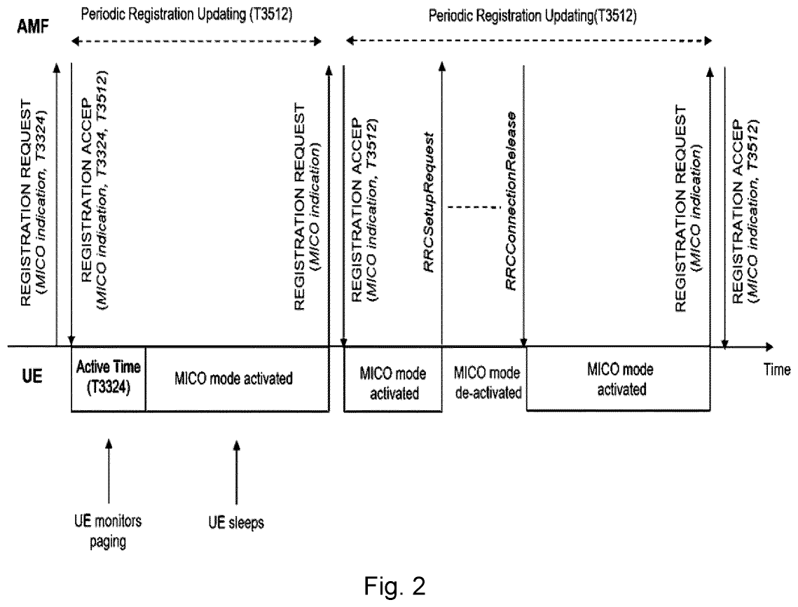

FIG. 3 illustrates a schematic block diagram illustrating embodiments of a wireless communications network.

FIG. 4 illustrates a combined flowchart and signalling scheme

FIG. 5 is a flowchart depicting embodiments of a method.

FIG. 6 is a flowchart depicting embodiments of a method.

FIG. 7 is a flowchart depicting embodiments of a method.

FIG. 8 is a diagram depicting an example scenario of embodiments herein.

FIG. 9 is a schematic block diagram illustrating embodiments of a first UE.

FIG. 10 is a schematic block diagram illustrating embodiments of a radio network node.

FIG. 11 is a schematic block diagram illustrating embodiments of a network node.

FIGS. 12, 13, 14 schematically illustrates a communication system in accordance with some embodiments.

### DETAILED DESCRIPTION

As summarized above, as part of developing embodiments herein the inventors have identified one or more problems with multicast sessions as introduced in the summary, which will be further discussed in more detail below. In embodiments herein the term MBS session or MBS multicast session may refer to any suitable multicast session, and the terms may be used interchangeably to define the same type of multicast session. If not explicitly stated otherwise, a session as used herein may be an MBS multicast session.

When a UE joins before an MBS session starts, the UE may be rejected, as stated in 3GPP TS 24.501, with a reject cause indicating “MBS session has not started or will not start soon” and a network node may then optionally include an MBS back-off timer when to try again, e.g., up to 32 hours. This means that a UE joining too early will waste resources as it may need to re-join the session again. Furthermore, as discussed above, when a large group of UEs are requested to transition to connected mode at exactly the same time, this will cause a congestion due to many requests within the same time period, and thereby delay a time until all UEs have entered RRC_CONNECTED. As a consequence, this will delay a time until all UEs has joined the MBS session. Due to UE clock inaccuracy between UEs and a time granularity use by the UEs, the UEs transitioning to an RRC connected state may not end up on exactly the same PRACH occasion, but the access attempts will be highly concentrated and with a high number of UEs, a lot of conflicts may occur, i.e. where same UEs intends to use the same PRACH occasion to transition to an RRC connected state.

Furthermore, the following additional problems can be identified:
In Rel-17 UEs that are in RRC_IDLE or RRC_INACTIVE will be group paged when a multicast MBS session is activated. But in case the activation time is scheduled and configured in the UE, such that the UE is to transition to an RRC connected state when the session is to be activated, then paging resources are wasted when the UE in eDRX or MICO mode wakes-up and starts monitoring paging, instead of just going to RRC_CONNECTED immediately. When a UE monitors paging instead of transitioning immediately to connected mode in view of a known activation time, the UE may discover that the MBS session will be activated much later, and the UE may then be released due to inactivity. This process may then happen multiple times without any multicast transmission, and may require the UE to transition in and out of a connected mode, which is power consuming,
When a number of UEs, e.g., a large group of UEs, try to access and establish a connection at exactly the same time e.g. at a scheduled activation time of an MBS Session, then this will cause congestion, and delay the time until all UEs have entered RRC_CONNECTED,
When a network node in the CN activates an MBS session in the RAN, the CN network node may immediately start transmitting multicast transmission on the MBS session even though some UEs may not have joined the MBS session, e.g., since some UEs may still need to be paged, may need to join, and/or may need configured to receive multicast, i.e., they need to be configured with a multicast MRB.
When a UE enters RRC_CONNECTED at a scheduled activation time of an MBS session, then multicast transmissions can be expected to start soon, however, if they do not or the multicast transmissions is marginally delayed, the UE may be released to RRC_INACTIVE or RRC_IDLE due to inactivity. This means that UEs may waste power and signalling resources by transitioning to RRC_CONNECTED, being released to RRC_INACTIVE or RRC_IDLE, and may need to reconnect again, while also risking missing multicast transmissions.

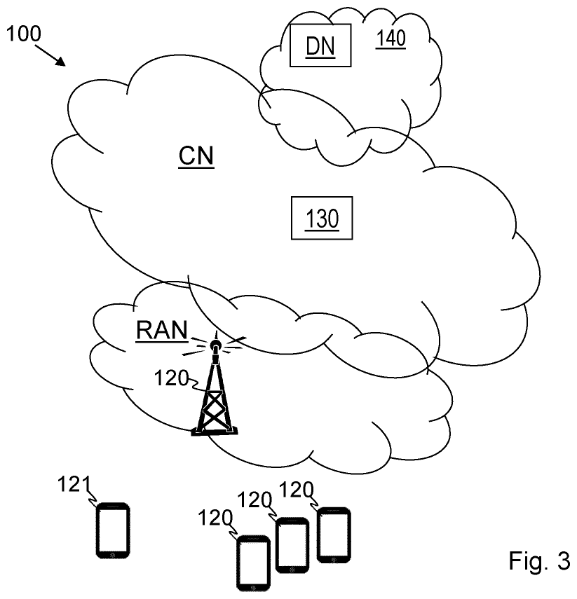

FIG. 3 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Radio network nodes such as a radio network node 110 operates in the wireless communications network 100. The network node 110 may provide a number of cells referred, and may use these cells for communicating with any one or more suitable UEs operating in these cells. The radio network node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any cell served by the radio network node 110, e.g. depending on the radio access technology and terminology used. In particular, the radio network node 110 may be able to handle MBS sessions and associated MBS session multicast communication. The radio network node 110 may at least partly be configured to hand an RRC state for UEs. The radio network node 110 may at least partly be configured to forward MBS session communication and/or other communication from network nodes in the CN to one or more UEs and/or vice versa from UE to the CN. MBS broadcast and multicast data may be strictly in Downlink (DL) only. In a connected mode, Uplink (UL) signalling may exist for both MBS broadcast and multicast.

UEs operate in the wireless communications network 100, such as a first UE 121. A set of UEs 120 may also operate in the wireless communications network 100. The first UE 121 and/or the set of UEs may respectively provide radio coverage by means of a number of antenna beams, also referred to as beams herein.

The first UE 121 and the set of UEs may respectively e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the radio network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

The first UE 121 and/or any one or more UEs in the set of UEs 120 may be a Rel-18 capable UE, or a Rel-17 capable UE, or a Rel-16 capable UE. In some embodiments. The first UEs 121 capabilities may or may not be known by RAN or CN entities.

Any one or both of the first UE 121 and the second UE 122 may be part of one or more groups of UEs (not shown), which respective groups of UEs may be part of the same multicast MBS session, and/or may be configured to join the same multicast MBS session.

The first UE 121 may be capable of operating using any suitable RRC state, e.g., RRC Inactive, while receiving multicast session data.

The first UE 121 may be capable of operating using different DRX and/or eDRX configurations, e.g., switchable by the first UE 121.

The first UE 121 may be capable of activating and/or deactivating a MICO mode.

The first UE 120 and the set of UEs 120 may be part of the same group, e.g., which are to handle an MBS session. The MBS session may be for multicast data.

CN nodes such as a network node 130 operates in the wireless communications network 100. The network node 130 may be configured to inform the radio network node 110 where a session is provided between the respective UE and network node about a session status change of the MBS session. Thus the network node 130 may be configured to inform, e.g., signal, each or any network node such as the radio network node 110 where a session, e.g., multicast MBS session, is provided, e.g., between which one or more UEs and which network node, and/or about a session status change of the MBS session. The network node 130 may be configured to transmit indications of a scheduled and/or tentatively scheduled activation time of an MBS session, i.e. when transmission of multicast data in an MBS session is scheduled or tentatively scheduled to start. The information may be sent to the first UE 121 by one or more indications in any suitable manner, for example in a service announcement. To avoid congestion, the network node 130 may be configured to transmit to the first UE 121 and/or to the set of UEs 120, a time window, e.g., before the scheduled and/or tentatively scheduled activation time of the MBS session. The time window may be communicated with the scheduled and/or tentatively scheduled activation time of the MBS session, e.g., as part of the same service announcement. In this way, different UEs, e.g., the first UE 121 and UEs as part of the test of UEs may select, e.g., randomly, different frames in the time window for when to transition to RRC_CONNECTED before the MBS session is activated. As different frames are selected, congestion is reduced. All communication from between the UE and the network node 130 may be relayed/forwarded by a radio network node in the RAN, e.g., the radio network node 110.

The network node 130 may be an Application Server (AS). alternatively, the network node 130 may be part of any suitable CN network node.

Methods herein may be performed by the first UE 121, the radio network node 110, and/or the network node 130. As an alternative, a Distributed Node (DN) and functionality, e.g. comprised in a cloud 140 as shown in FIG. 3, may be used for performing or partly performing the methods and embodiments herein.

Some embodiments herein may relate to supporting MBS multicast and UE power saving, i.e. when the first UE 121 is configured with eDRX or MICO mode. An example is a large number of RedCap devices in an industrial setting, e.g., including the first UE 121 and the set of UEs 120, that typically are in eDRX or MICO mode to save power, but that once in a while require MBS multicast e.g. to perform a firmware update. Embodiments herein may relate to any one or more of:
the first UE 121 and/or the set of UEs 120 will have low congestion when all try to transition to RRC_CONNECTED as random access transition to RRC_CONNECTED is spread out in a time window, and/or
the first UE 121 and/or the set of UEs 120 do not have to transition back and forth between RRC_CONNECTED and RRC_IDLE/RRC_INACTIVE,
the first UE 121 and/or the set of UEs 120 can receive MBS multicast transmission in RRC_INACTIVE, and
the first UE 121 and/or the set of UEs 120 may remain in RRC_CONNECTED while waiting for MBS multicast transmission.

Embodiments herein address at least some above-mentioned problems. A short summary of some example features of embodiments herein follow below.

Some embodiments herein may relate to not group paging UEs, e.g., the first UE 121 and/or the set of UEs 120, also referred to as refraining from group paging UEs, when a session activation is scheduled for an MBS session. This means that the UEs e.g., the first UE 121 and/or the set of UEs 120, may themselves be configured to transition to an RRC connected state before a scheduled session activation time, e.g., point in time, or tentatively scheduled session activation time. In other words, the UEs of embodiments herein may transition without the use of group paging messages.

Some embodiments herein may distribute random access attempts, e.g., RACH procedures also referred to as PRACH procedures herein, needed to be performed during or before an activation time for an MBS session for transitioning a set of UEs to an RRC connected state. The random access attempts may be distributed over a time window to avoid congestion.

Some embodiments herein may relate to transmitting multicast transmission(s) a set time period, e.g., 1 second after an MBS session activation.

This ensures that more UEs are connected in RRC connected and may receive the multicast transmission.

Some embodiments herein may relate to when the first UE 121 triggers a connection establishment, i.e. when performing random access to transition to an RRC connected state, then the first UE 121 may indicate that the connection was triggered due to a scheduled activation time. In these embodiments, radio network node 110, e.g., a gNB, associated with the RRC state of the first UE 121, may be triggered to not release the first UE 121 due to inactivity, e.g. desist from releasing the first UE 121 due to inactivity, at least until the multicast transmissions start. In other words, even if the first UE 121 will have inactivity, as it is known that the first UE 121 has transitioned to RRC connected state for the scheduled activation of MBS multicast transmission, the radio network node 110 may then allow the first UE 121 to remain in a RRC connected state when waiting for the MBS multicast transmission.

Some embodiments herein may relate to the first UE 121 to be configured to handle multicast the same as a broadcast for MBS sessions. This means that the first UE 121 may be configured to monitor and receive multicast transmission for an MBS session while being in an RRC inactive state. For example, when the first UE 121 is in RRC_INACTIVE and is configured with eDRX, and has a valid PTM configuration, then the first UE 121 may start to monitoring a G-RNTI of the multicast sessions at a scheduled activation time, e.g., referred to as TactivationTime, while the first UE 121 may remain in RRC_INACTIVE.

In other words, embodiments herein may relate to improving resource efficiency when handling MBS sessions, e.g., by ensuring that UEs, e.g., the first UE 121, does not iteratively have to transition between RRC states when waiting for upcoming MBS session transmissions, and/or by allowing early access for UEs to join an MBS session and/or by reducing congestion when multiple UEs join an MBS session and needs to transition to an RRC connected state within a same time period.

Furthermore, a few more advantages will be discussed below.

According to some embodiments herein, paging resources will not be wasted, e.g., when a scheduled activation time is configured in the first UE 121 for an MBS session. This is since no paging is needed as the first UE 121 may be configured to transition to an RRC connected state without the need of first being paged. Additionally or alternatively, the first UE 121 may be maintained in an RRC connected state until multicast transmissions start for an MBS session after a scheduled activation time. This means that even if the first UE 121 is inactive, as it is waiting for MBS multicast transmission, it is not released back to RRC inactive as that would mean that the first UE 121 would again need to be paged and transition back to RRC connected when the multicast transmission starts.

According to some embodiments herein, congestion is avoided when a large group of UEs, e.g., the first UE 121 and the set of UEs 120, tries to access at the same scheduled activation time. This is by indicating a time window related to the scheduled activation time. The time window may be indicated as a time period, e.g., seconds, before the activation time of the session. Each or any one or more UEs of the set of UEs 120 and/or the first UE 121 may select a frame within the time window to transition to an RRC connected state and thereby same PRACH occasions are less likely to be by the same UE. The frame selected by each or any UE from the time window may be randomized, pseudorandomized, based on a UE parameter that may vary between UEs, e.g., an internal clock, temperature, UE identifier, etc. Randomized or pseudorandomized may mean generating a frame selection based on any suitable randomized or pseudorandomized function.

According to some embodiments herein, multicast transmissions are not immediately started at a scheduled activation time. In other words, multicast transmission on MBS sessions may be delayed by a statically or dynamically set time period. This means that a likelihood that all the UEs, e.g., the first UE 121 and/or the set of UEs 120, will receive all the multicast data is increased. This is since some UEs may try to join close to the scheduled activation time, and may be delayed, e.g., due to unexpected events, congestion, etc.

According to some embodiments herein, the first UE 121, e.g., when being Rel-18 compliant, may also receive multicast in RRC_INACTIVE for an MBS session. In these embodiments, the Rel-18 compliant UE may be configured to remain in RRC_INACTIVE and to monitor paging according to a configured eDRX for the Rel-18 compliant UE, but in addition, at the scheduled activation time, also be configured to start monitoring multicast data.

A number of embodiments will now be described, some of which may be seen as alternatives, while some may be used in combination.

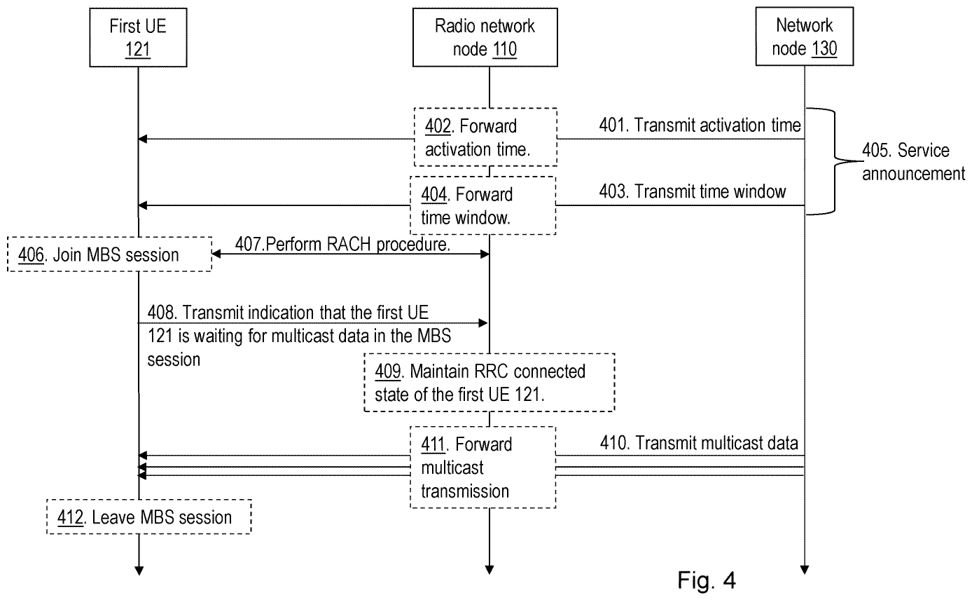

FIG. 4 illustrates a combined flowchart and signalling scheme according to some example embodiments herein.

The network node 130 may transmit 401 a first indication indicative an activation time of an MBS session. The activation time may be a scheduled activation time, e.g., a point in time, when a firmware download is to happen. The activation time may be a tentatively scheduled activation time, e.g., a point in time, when a firmware download is likely to happen.

The first indication indicative of the activation time may be transmitted to the first UE 121, and optionally to the set of UEs 120. This is related to and may be combined with Actions 501, 601 described below.

The first indication may be a non-limiting embodiment of indicating the activation time of the MBS session. However, other manners of indicating the same may apply for other embodiments, e.g., by explicit or implicit indication over communication, or by predefined or preconfigured means.

The first indication indicative of the activation time may be transmitted to the first UE 121 via RAN. The radio network 110 may receive from the network node 130, and may forward 402 the first indication of the activation time to the first UE 121. This is related to and may be combined with Action 703 described below.

The network node 130 transmits 403 a second indication indicative a time window, e.g., a time window before an activation time and/or start time of the MBS session. This is related to and may be combined with Actions 503, 602 described below.

The second indication may be arranged to trigger the first UE 121 to, upon receiving the second indication, to transition to an RRC Connected state, by triggering the UE 121 to select a frame within the time window to use for a PRACH, procedure.

The time window may be a time interval for which a UE in the set of UEs 120 and/or the first UE 121 can select a time slot such as a frame for when to transition to an RRC connected state. The first UE 121 may then join the MBS session before the indicated activation time. A time window when used herein e.g., means a time interval, and may be indicated by a time period, e.g., in seconds, which time window may be represented as an amount of time units, e.g., seconds/milliseconds, before the activation time, e.g., as indicated in the second indication. In other words, the second indication may indicate a duration of the time window, which is to end at the activation time indicated in the first indication. The second indication may alternatively indicate a start point in time for the time window, and wherein the activation time may indicate an end point in time for the time window.

The second Indication indicative of the time window may be transmitted to the first UE 121 via RAN. The radio network 110 may receive from the network node 130, and may forward 404 the second indication of the time window to the first UE 121. This is related to and may be combined with Action 703 described below.

The activation time and the time window may be transmitted to the first UE 121 and/or the set of UEs 120, e.g., forwarded by the radio network node 110, in a service announcement 405. The service announcement 405 may comprise a scheduled or tentatively scheduled activation time for the MBS session, and a time window for when to transition to an RRC connected state, and optionally an identifier associated with the session or groups which are part of the session, e.g., a Temporary Mobile Group Identity (TMGI).

The first UE 121 may join 406 the MBS session in a same time period as the set of UEs 120. This is related to and may be combined with Actions 502, 504 described below.

To join the MBS session the first UE 121 may perform 407 a RACH procedure to transition to an RRC connected state. This is related to and may be combined with Actions 502, 504 described below.

To avoid congestion when joining the MBS session, the first UE 121 may join the MBS session based on the received time window, e.g., by selecting a frame for when to perform 407 the RACH procedure when transitioning to an RRC connected state, when joining the MBS session. This is related to and may be combined with Actions 502, 504 described below.

The first UE 121 may further transmit 408 a third indication indicative of that the first UE 121 is waiting for multicast data in the MBS to the radio network node 110. The third indication may indicate a remaining time until the activation time of the MBS session. The radio network node 110 may then be informed that even if the first UE 121 is inactive, it should not be released to RRC_INACTIVE or RRC_IDLE. The radio network node 110 may maintain the RRC connected state of the first UE 121. In other words, the radio network node 110 may refrain 409 from releasing the first UE 121 to an RRC inactive state at least until the activation time of the MBS session. This is related to and may be combined with Actions 506, 701, 702 described below.

At the activation time, or after a set time period after the indicate activation time, the network node 130 may transmit 410 one or more multicast transmissions, e.g., messages, on the MBS session towards the first UE 121 and/or the set of UEs 120. This is related to and may be combined with Actions 508, 603 described below.

The transmission of the one or more multicast transmissions may be relayed via the RAN, e.g., the radio network node 110 which forwards 411 the multicast transmission(s). This is related to and may be combined with Action 703 described below.

The first UE 121 will receive the multicast transmissions and may then leave 412 the MBS session 412. The first UE 121 may be triggered to transition back to an initial power saving configuration, e.g., an initial eDRX configuration and/or MICO mode. This is related to and may be combined with Action 509 described below.

Additionally or alternatively, the first UE 121 may at any suitable point, when in a power saving state, e.g., eDRX and/or MICO mode, and has a valid PTM configuration, e.g., for RRC_INACTIVE, trigger the first UE 121 to start monitoring a Group Radio Network Temporary Identifier, G-RNTI, of the MBS session, e.g., at the activation time indicated in the first indication. This monitoring of the G-RNTI of the MBS session may occur in response to establishing a valid PTM configuration and entering a power saving state. When the first UE 121 is in RRC_Inactive, it may be configured to monitor Paging Occasions (POs) using a Paging-RNTI (P-RNTI) scheduled according to eDRX/DRX, and/or monitor the G-RNTI according to the PTM-DRX In other words, the first UE 121 may optionally be configured to handle multicast in the MBS session in the same way as broadcast transmissions in the MBS session when in an RRC_INACTIVE state. The MBS session may thus be monitored at certain intervals and/or when paged, e.g., based on a timer and/or the eDRX/DRX cycle.

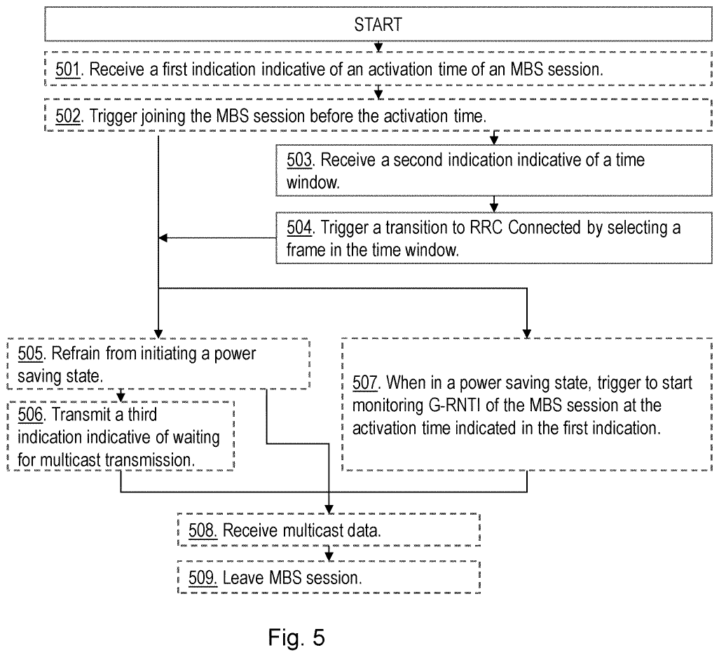

FIG. 5 illustrates an example method performed by the first UE 121 for handling an MBS session in the wireless communications network 100. The MBS session may be for multicast data. The method may also, e.g., concurrently, be performed by any one or more UEs in the set of UEs 120 which are to handle the same MBS session. The method comprises any one or more of the following actions, which actions may be taken in any suitable order. Optional actions may be indicated by dashed boxes in FIG. 5. The first UE 121 may be configured with an eDRX configuration and/or may be configured with a MICO mode.

### Action 501

In some embodiments, the first UE 121 receives a first indication as transmitted by the network node 130. The first indication may be transmitted by the network node 130 via the radio network node 110, e.g., forwarded by the radio network node 110 to the first UE 121 and/or to the set of UEs 120. The first indication may be indicative of an activation time of the MBS session, for example a scheduled activation time or a tentative activation time of the MBS session. In some of these embodiments, the first UE 121 has not already joined the MBS session when receiving the first indication. The activation time may further be a series of activation times, e.g., points in time.

The first indication may be received as a service announcement, e.g., received as part of a service announcement message.

The start time, scheduled/tentative activation times in the service announcements may have a second granularity. This is since because the first UE 121 may have a clock which runs no more accurate then +/−1 second.

### Action 502

In some embodiments, upon receiving the first indication, the first UE 121 triggers the first UE 121 to join the MBS session before the indicated activation time. In this way, a need to page the first UE 121 to join the MBS session is removed, and signalling resources are not wasted.

### Action 503

The first UE 121 receives a second indication as transmitted by the network node 130. The second indication may be transmitted by the network node 130 via the radio network node 110, e.g., forwarded by the radio network node 110 to the first UE 121 and/or to the set of UEs 120. The second indication is indicative of a time window before an activation time and/or start time of the MBS session. The time window may be a time interval e.g., as defined by a time duration before the activation time of the MBS session, e.g., with the activation time as an end point in time. In other words, the second indication may indicate a time interval or a time duration before the activation time, to define the time window. A UE in the set of UEs 120 and/or the first UE 121 may select a time slot such as a frame, out of the time window, for when to transition to an RRC connected state.

The time window may have a range in the order of seconds, and may be specified with a second granularity. For example the time window could be 4 seconds before the activation time, e.g., start 4 seconds before the activation time and end at the activation time.

The second indication may be received as a service announcement, e.g., received as part of a service announcement message.

The second indication may be received with the first indication, e.g., in the same service announcement message.

### Action 504

Upon receiving the second indication, the first UE 121, is triggered to transition to an RRC Connected state, e.g., RRC_CONNECTED, by selecting a frame within the time window to use for a PRACH procedure. PRACH procedure as used herein may mean any suitable random access procedure, with respect to the time window but typically using PRACH. While a frame may be used for embodiments herein, any suitable time slot or selection of time period is applicable to embodiments herein. The frame selected by the first UE 121 from the time window may be any one or more out of: randomized, pseudorandomized, based on a UE parameter that may vary between UEs, e.g., an internal clock, temperature, UE identifier, etc. Randomized or pseudorandomized may mean generating a frame selection based on any suitable randomized or pseudorandomized function. As the frame is selected from the time window, there is less likelihood for the first UE 121 to attempt to perform a RACH procedure at the same time the set of UEs 120. This is since the UEs in the set of UEs 120 may also select a frame in the time window in a corresponding manner, effectively distributing RACH procedures from the first UE 121 and the set of UEs over time.

### Action 505

In some embodiments, when the first UE 121 has joined the MBS session, the first UE 121 may refrain from initiating a power saving state, e.g., refrain from initiating Extended Discontinuous Reception, eDRX, and/or activating Mobile Initiated Connection Only, MICO, mode for the first UE 121. Instead the first UE 121 may optionally use a DRX configuration when in an RCC_INACTIVE or RRC_IDLE state, e.g., with lower sleep time than the eDRX configuration and/or MICO mode. This is to ensure that the first UE 121 does not become unreachable when it has joined the MBS session. This is ensured since the first UE 121 may now be able to be paged e.g., for informing of session activation

The DRX configuration may be an agreement between the radio network node 110 and the first UE 121, which influences Paging Opportunities the radio network node 110 may use for paging the first UE 121. When the MBS session is activated, the first UE 121 may be paged using the normal DRX, e.g. every 1.28 sec, for a short while. When the first UE 121 is in MICO mode, the first UE 121 may not listen to paging at all. When the first UE 121 is in eDRX the first UE 121 may only listen to paging sporadically e.g. up to every 3 hours for 5 sec, i.e. the first UE 121 may be likely to miss the paging for session activation.

When the first UE 121 has joined the MBS session and the first UE 121 is configured with eDRX, then the first UE 121 may refrain from using the eDRX, but instead may use a set DRX configuration, e.g., when in RRC_IDLE or RRC_INACTIVE.

Additionally or alternatively, when the first UE 121 has joined the MBS session, and when the first UE 121 is configured with MICO mode, then the first UE 121 may be configured to not activate the MICO mode, when in RRC_IDLE.

### Action 506

In some embodiments, the first UE 121 may transmit to the radio network node 110, e.g., a gNB, a third indication indicative of that the first UE 121 is waiting for multicast transmission to start in the MBS session. Since the radio network node 110 is informed of that the first UE 121 is waiting for multicast transmission to start in the MBS session, the radio network node 110 is enabled to refrain from releasing the first UE 121 to an RRC inactive state, e.g., if there is inactivity in the first UE 121.

The first UE 121 may further transmit to the radio network node 110, a fourth indication indicative of a remaining time until a start time and/or activation time of the MBS session, e.g., as received in the first indication.

In this way, the radio network node 110 is informed of a remaining time until the activation of the MBS session, and the radio network node 110 is accordingly enabled to refrain from releasing the first UE 121 to an RRC inactive state, at least until the activation time of the MBS session.

The fourth indication may be transmitted as part of the third indication, e.g., in the same message.

### Action 507

In some embodiments, when the first UE 121 is configured with a power saving state, e.g., eDRX and/or MICO mode, the first UE 121 may trigger the first UE 121 to start monitoring a G-RNTI of the MBS session, e.g., at a start time and/or activation time of the MBS session, as indicated in the first indication. This means that the first UE 121 may, similar to a behavior for MBS broadcast in eDRX and/or MICO mode, be able to receive MBS multicast in eDRX and/or activated MICO mode. The first UE 121 may then periodically wake up to receive MBS multicast, e.g., at an activation time such as indicated in the first indication.

The activation time may be handled in an application e.g., clock running in sec and/or by that a timer is set, e.g., the activation time, when the first UE 121 may provide an indication to the lower layer (AS layer) e.g. to initiate random access.

### Action 508

In some embodiments, the first UE 121 may receive, as transmitted by the network node 130, one or more multicast transmissions on the MBS session.

The one or more multicast transmissions on the MBS session may be transmitted by the network node 130 via the radio network node 110, e.g., forwarded by the radio network node 110 to the first UE 121 and/or to the set of UEs 120.

The one or more multicast transmissions may be transmitted as one or more messages.

The one or more multicast transmissions may be a firmware update for the first UE 121 and/or the set of UEs 120.

The one or more multicast transmissions may in some embodiments be arranged to be sent with a delay of at least a first time period after a start time and/or activation time of the MBS session, e.g., as received in the first indication. This allows for all UEs to have time to join the MBS session and/or to setup an MRB configuration. This means that the probability of that more UEs in the MBS session, e.g., out of the first UE 121 and/or the set of UEs 120, will receive the one or more multicast transmissions is increased from starting to send immediately at the activation time.

### Action 509

In some embodiments, the first UE 121 may trigger the first UE 121 to leave the MBS session. When the first UE 121 leaves the MBS session, the first UE 121 triggers to transition back to an initial power saving configuration, e.g., an initial eDRX configuration and/or MICO mode.

In some embodiments, the first UE 121 may trigger to transition back to an initial power saving configuration, e.g., an initial eDRX configuration and/or MICO mode, based on whether the first UE 121 is active in any other MBS session. In other words, if the first UE 121 is active in other MBS sessions, the first UE 121 may not transition back to the initial power saving configuration.

In some embodiments, the first UE 121 may request to leave. But the radio network node 110 and/or the network node 130 may also indicate to the first UE 121 to leave, e.g., using paging. When the radio network node 110 and/or the network node 130 releases the session, then all UEs, e.g., the set of UEs 120 may automatically have left the MBS session, i.e. there is no group for the MBS session anymore.

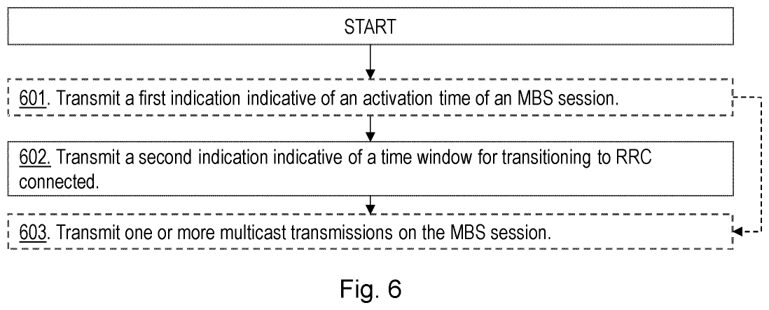

FIG. 6 illustrates an example method performed by the network node 130 e.g., an AS, for handling an MBS session in the wireless communications network 100. The MBS session may be for multicast data. The method comprises the following actions, which actions may be taken in any suitable order. Dashed boxes in FIG. 6 may illustrate optional actions. Any one or more features of actions 501-509 above may also apply to, and/or be combined with the actions below and vice versa.

### Action 601

In some embodiments, the network node 130 may transmit towards the first UE 121, the first indication indicative of the activation time of the MBS session. The first indication may additionally be sent to the set of UEs 120.

Transmitting towards the first UE 121 means to transmit to the first UE 121, e.g., via RAN, to reach the first UE 121. This may mean that the network node 130 may transmit the first indication to the radio network node 110 which forwards the first indication to the first UE 121 and/or to the set of UE 120.

In some of these embodiments, when the first UE 121 has not already joined the MBS session, the first UE 121 is arranged to be triggered upon receiving the first indication, to join the MBS session before the indicated activation time.

The first and/or the second indication, may be transmitted as part of a service announcement message, e.g., as in actions 501-504 above.

### Action 602

The network node 130 transmits towards the first UE 121, the second indication indicative of the time window before the activation time and/or the start time of the MBS session. The second indication may additionally be sent to the set of UEs 120.

Transmitting towards the first UE 121 means to transmit to the first UE 121, e.g., via RAN, to reach the first UE 121. This may mean that the network node 130 may transmit the second indication to the radio network node 110 which forwards the second indication to the first UE 121 and/or to the set of UE 120.

The first UE 121 is arranged to be triggered upon receiving the second indication, to transition to an RRC Connected state, e.g., RRC_CONNECTED, by selecting a frame within the time window to use for a PRACH procedure.

The first and/or the second indication, may be transmitted individually or together, e.g., as part of a service announcement message, e.g., as in actions 501-504 above.

### Action 603

In some embodiments, the network node 130 may transmit towards the first UE 121, one or more multicast transmissions on the MBS session. The one or more multicast transmissions may be arranged to be sent with a delay of at least a first time period after a start time and/or activation time of the MBS session, e.g., as transmitted in the first indication.

In some embodiments, transmitting the first indication, the second indication, and/or the one or more multicast transmissions, is/are transmitted via the radio network node 110. The radio network node 110 may be configured to forward the first indication, the second indication, and/or the one or more multicast transmissions to the first UE 121 and/or to the set of UEs 120.

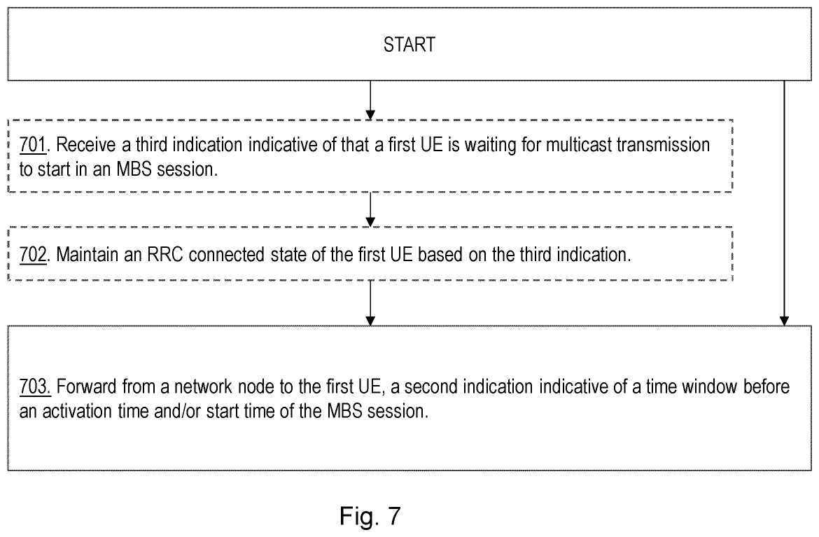

FIG. 7 illustrates an example method performed by the radio network node 110 e.g., a gNB, for handling an MBS session in the wireless communications network 100. The MBS session may be for multicast data. The method comprises the following actions, which actions may be taken in any suitable order. Dashed boxes in FIG. 7 may illustrate optional actions. Any one or more features of actions 501-509 and/or actions 601-603, above may also apply to, and/or be combined with the actions below and vice versa.

### Action 701

In some embodiments, the radio network node 110 may receive from the first UE 121, the third indication indicative of that the first UE 121 is waiting for multicast transmission to start in the MBS session. At this point in time, the radio network node 110 may have forwarded the first and second indication, as described in Action 703. In this way, the radio network node 110 is informed that even if the first UE 121 would go inactive, the first UE 121 should stay in a connected RRC state as it is waiting for multicast transmission in the MBS session which should commence shortly.

Receiving the third indication may further comprise receiving from the first UE 121, a fourth indication indicative of a remaining time until a start time and/or activation time of the MBS session, e.g., as indicated by the first indication.

The fourth indication may be received as part of the third indication, e.g., in the same message.

### Action 702

In some embodiments, the radio network node 110 may maintain a RRC Connected state of the first UE 121 based on the third indication. In some embodiments, maintaining the RRC connected state of the first UE 121 further comprises refraining from releasing the first UE 121 from the RRC connected state at least until the start time and/or activation time. In other words, if the first UE 121 is inactive, the radio network node 110 will not perform an RRC release procedure as it is known that the first UE 121 is waiting for multicast transmission to commence shortly. If the first UE 121 were to be released, it would miss multicast transmissions and/or have to transition back to RRC connected state again which would waste signalling resources and potentially increase congestion.

In some embodiments, maintaining the RRC connected state of the first UE 121 is further based on the fourth indication. This means that the first UE 121 may not be released to RRC_INACTIVE or RRC_IDLE, at least until the activation time of the MBS session.

In some embodiments, maintaining the RRC connected state of the first UE 121 is performed to ensure that the first UE 121 is not released to an RRC inactive or RRC idle state due to inactivity before multicast transmission in the MBS session has started.

### Action 703

The radio network 110 forwards, from the network node 130 to the first UE 121, the second indication indicative of the time window before the activation time, and/or the start time of the MBS session, e.g., as in actions 503, 602.

The radio network node 110 may further forward, from the network node 130 to the first UE 121, any one or more out of:
the first indication of the activation time of the MBS session, e.g., as in actions 501, 601, and
one or more multicast transmissions, e.g., as in actions 508, 603.

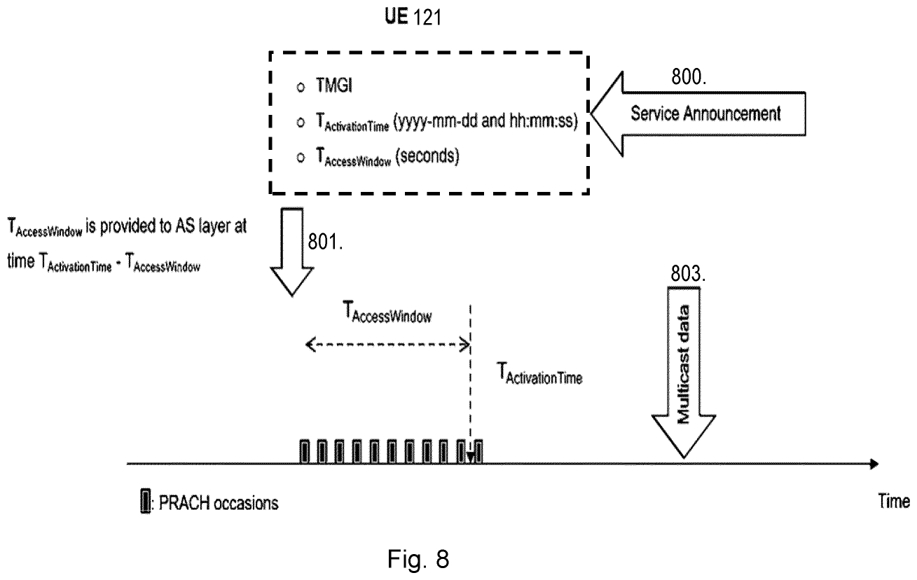

FIG. 8 illustrates an example scenario of some embodiments herein. A service announcement 800 may be transmitted to the first UE 121 and optionally to the set of UEs 120. The service announcement 800 may comprise the first indication and the second indication. In other words, the service announcement 800 may comprise the activation time of an MBS session and the time window, also referred to as an access window. The service announcement may also comprise a TMGI associated with the MBS session. The service announcement 800 may be transmitted from the network node 130, e.g., via the radio network node 130, to the first UE 121 and optionally to the set of UEs 120. The service announcement 800 may e.g., be communicated as part of actions 501, 503, 601, and 602.

The activation time may be a scheduled activation time or a tentatively scheduled activation time, e.g., in format yyyy-mm-dd and hh:mm:ss.

The time window may be a time before the activation time for when UEs, e.g., the first UE 121 shall select a frame for when to transition to an RRC connected state, e.g., as part of joining the MBS session.

As an example, the time window may be provided 801 to the first UE 121 and/or the set of UEs 120, e.g., provided to an AS layer. The time window may be provided 801 to the first UE 121 and/or the set of UEs 120 at a time based on a difference between the activation time and the time window, e.g., at a time activation time deducted by the time window. The first UE 121 and/or the set of UEs 120 may obtain PRACH occasions before the activation time for when they can attempt to transition to an RRC connected state such that they are ready to receive multicast data 803, which is transmitted a time later than the activation time.

The first UE 121, and/or the set of UEs 120 may all select a PRACH occasion to use for a RACH procedure for transitioning to an RRC connected state. The selection may be performed randomly or pseudo randomly, or at least with a distribution such that if there is congestion, different UEs will select different PRACH occasions within the time window, e.g., before the activation time.

### Further Variations and Embodiments

In some embodiments, when the first UE 121 has joined a multicast MBS session and the first UE 121 is configured with eDRX, then the first UE 121 does not use the eDRX, but instead may use a normal/predefined DRX configuration when in RRC_IDLE or RRC_INACTIVE.

In some embodiments, when the first UE 121 has joined a multicast MBS session and the first UE 121 is configured with MICO mode, then the first UE 121 does not activate MICO mode when in RRC_IDLE.

In some embodiments, when the first UE 121 is configured with one or a series of scheduled activation time(s), e.g., referred to as tActivationTime, or one or a series of tentative activation time(s), e.g., referred to as tTentativeTime, via a service announcement, e.g., as in actions 501-504, then the first UE 121 may ignore a previously configured Start Time of the MBS session, if configured.

In some embodiments, when the first UE 121 has received a scheduled activation time, e.g., tActivationTime, via service announcement, e.g., as in action 501, then the first UE 121 may transition to RRC_CONNECTED before the scheduled activation time, and joins the session if the first UE 121 did not already do so, e.g., as in action 502

In some embodiments, when the first UE 121 has received a tentative activation time, e.g., tTentativeTime, via service announcement, e.g., as in action 501, and when the first UE 121 already has joined the MBS session, then the first UE 121 may initiate monitoring paging, starting at the tentative activation time and during a configured Paging Transmission Window (PTW).

An eDRX may be request/negotiated between the first UE 121 and the network node 130 via NAS signalling, i.e. the first UE 121 may indicate that it supports, and would like to be configured with eDRX, and then an Access and Mobility management Function (AMF), e.g., as part of the network node 130, may decide to configure the PTW or eDRX configuration. The configured/negotiated eDRX may be signaled in a Paging message sent by the network node 130 to the radio network node 110 so it can page correctly.

When the first UE 121 is paged, the first UE 121 may transition to RRC_CONNECTED, otherwise the first UE 121 may be configured to go back to sleep, e.g., as configured by an eDRX or MICO mode configuration, after the PTW had ended.

In some embodiments, when the first UE 121 has received a tentative activation time, e.g., tTentativeTime, via service announcement, e.g., as in action 501, and has not joined the session yet, then the first UE 121 may be configured to transition to RRC_CONNECTED before the tentative activation time to join the session.

In some embodiments, when the first UE 121 has received an access window e.g., referred to as tAccessWindow, via service announcement, e.g., as in action 503, then the first UE 121 may initiate a PRACH selection in a random frame up to the activation time indicated in the service announcement, e.g., a scheduled activation time, a tentative activation time, or a start time (tActivationTime, tTentativeTime or Start time).

In some embodiments, when the network node 130 may be configured to not start multicast transmissions immediately after the activation time indicated in the service announcement, e.g., a scheduled activation time, a tentative activation time, or a start time (tActivationTime, tTentativeTime or Start time). Instead, the network node 130 may start the multicast transmission in the MBS session a short time period later, e.g., longer than a set time period. This may be to give the first UE 121 and/or the set of UEs 120 time to join the MBS session, and/or to give the radio network node 110 some time to configure the first UE 121 and/or the set of UEs 120 with an MRB.

In some embodiments, when the first UE 121 establishes an RRC connection triggered by a scheduled or tentative activation time indicated in the service announcement (tActivationTime or tTentativeTime), e.g., as received in action 501, then the first UE 121 uses a new establishment cause MulticastActivation. The establishment cause indicates to the radio network node 110 that the first UE 121 is waiting for multicast transmissions to start soon, e.g., within a set time period, and the radio network node 110 may use this indication to not release the first UE 121 due to inactivity until the multicast transmissions start.

In some embodiments, when the first UE 121 establishes an RRC connection triggered by a time indicated in the service announcement (tActivationTime, tTentativeTime or Start time), e.g., as in action 501, then the first UE 121 includes the remaining time until the time indicated in service announcement (tActivationTime, tTentativeTime or Start time) in a message 5 (MSG5), i.e., in procedures RRCSetupComplete and/or RRCResumeComplete. The radio network node 110 may use this information to not release the first UE 121 just before the multicast transmissions are supposed to start due to inactivity.

In some embodiments, when the first UE 121 in RRC_INACTIVE is configured with eDRX and has a valid PTM configuration, then the first UE 121 may start monitoring a G-RNTI of the multicast MBS session at the time indicated in the service announcement (tActivationTime, tTentativeTime or Start time), e.g., as indicated in the first indication, e.g., as in action 501.

In some embodiments, based on the first UE 121 implementation, e.g. preference to save power instead of receiving multicast, or an indication from upper layers that a multicast transmission were successful, e.g., a firmware download was successful, the first UE 121 leaves the MBS session and goes back into power saving. In other words, if eDRX/MICO are still configured for the first UE 121, this means that the first UE 121 goes back into eDRX in RRC_IDLE/RRC_INACTIVE and MICO mode may be activated in RRC_IDLE.

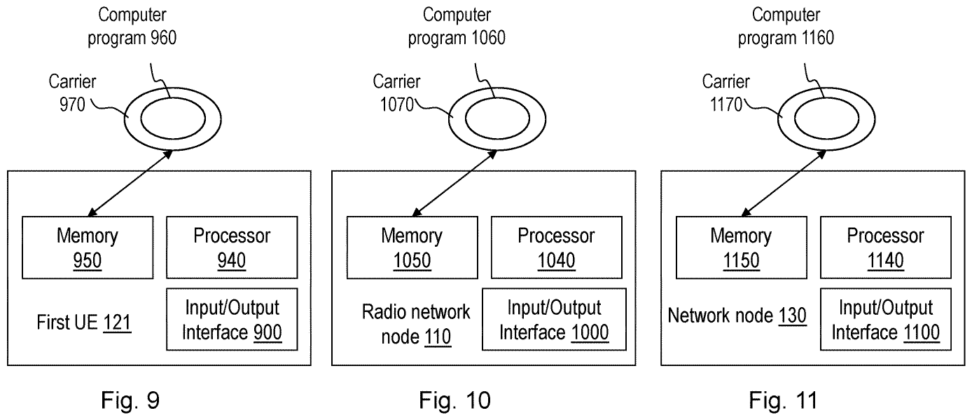

To perform the method actions above, the first UE 121 may comprise an arrangement depicted in FIG. 9. The first UE 121 may be configured to a handle an MBS session in the wireless communications network 100.

The first UE 121 may comprise an input and output interface 900 configured to communicate with any suitable entity described herein, e.g., the network node 130 and/or the radio network node 110. The input and output interface 900 may comprise a wireless receiver not shown, and a wireless transmitter not shown.

The embodiments herein may be implemented through a processor or one or more processors, such as at least one processor 940 of a processing circuitry in the first UE 121 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the first UE 121. One such carrier may be in the form of a CD ROM disc. It is however feasible with other data carriers such as a memory stick. The computer program code may furthermore be provided as pure program code on a server and downloaded to the first UE 121.

The first UE 121 may further comprise respective a memory 950 comprising one or more memory units. The memory comprises instructions executable by the processor in the first UE 121. The memory is arranged to be used to store instructions, data, configurations, and applications to perform the methods herein when being executed in the first UE 121.

In some embodiments, a computer program 960 comprises instructions, which when executed by the at least one processor, cause the at least one processor of the first UE 121 to perform the actions above.

In some embodiments, a respective carrier 970 comprises the respective computer program, wherein the carrier is one of an electronic signal, an optical signal, an electromagnetic signal, a magnetic signal, an electric signal, a radio signal, a microwave signal, or a computer-readable storage medium.

The first UE 121 may further be configured to perform any one or more out of actions 501-509 in any suitable order, e.g., by used of the at least one processor 940 and/or by use of a control unit, and/or by use of any other suitable means.

Those skilled in the art will also appreciate that the functional modules in the first UE 121, described below may refer to a combination of analog and digital circuits, and/or one or more processors configured with software and/or firmware, e.g. stored in the first UE 121, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

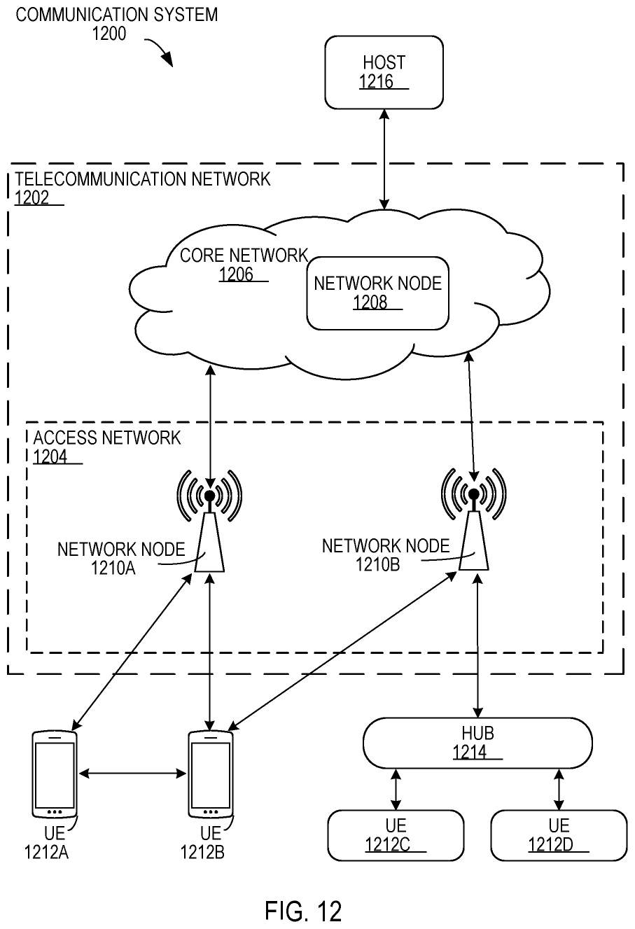

To perform the method actions above, the radio network node 110 may comprise an arrangement depicted in FIG. 10. The radio network node 110 may be configured to a handle an MBS session in the wireless communications network 100.

The radio network node 110 may comprise an input and output interface 1000 configured to communicate with any suitable entity described herein, e.g., the network node 130 and/or the first UE 121 and/or the set of UEs 120. The input and output interface 1000 may comprise a wireless receiver not shown, and a wireless transmitter not shown.

The embodiments herein may be implemented through a processor or one or more processors, such as at least one processor 1040 of a processing circuitry in the radio network node 110 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as a memory stick. The computer program code may furthermore be provided as pure program code on a server and downloaded to the radio network node 110.

The radio network node 110 may further comprise respective a memory 1050 comprising one or more memory units. The memory comprises instructions executable by the processor in the radio network node 110. The memory is arranged to be used to store instructions, data, configurations, and applications to perform the methods herein when being executed in the radio network node 110.

In some embodiments, a computer program 1060 comprises instructions, which when executed by the at least one processor, cause the at least one processor of the radio network node 110 to perform the actions above.

In some embodiments, a respective carrier 1070 comprises the respective computer program, wherein the carrier is one of an electronic signal, an optical signal, an electromagnetic signal, a magnetic signal, an electric signal, a radio signal, a microwave signal, or a computer-readable storage medium.

The radio network node 110 may further be configured to perform any one or more out of actions 601-603 in any suitable order, e.g., by used of the at least one processor 1040 and/or by use of a control unit, and/or by use of any other suitable means.

Those skilled in the art will also appreciate that the functional modules in the radio network node 110, described below may refer to a combination of analog and digital circuits, and/or one or more processors configured with software and/or firmware, e.g. stored in the radio network node 110, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

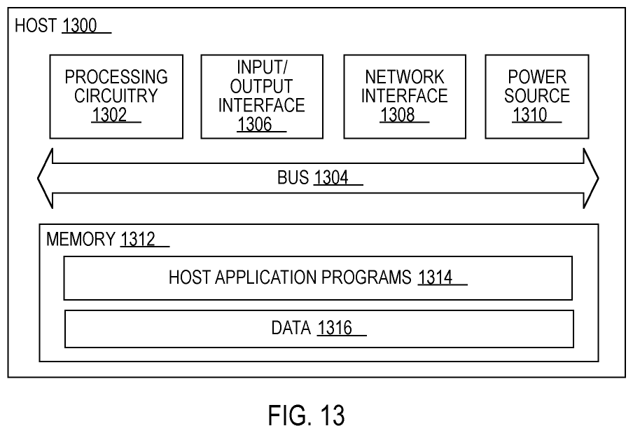

To perform the method actions above, the network node 130 may comprise an arrangement depicted in FIG. 11. The network node 130 may be configured to a handle an MBS session in the wireless communications network 100.

The network node 130 may comprise an input and output interface 1100 configured to communicate with any suitable entity described herein, e.g., the first UE 121, the set of UEs 120, and/or the radio network node 110. The input and output interface 1100 may comprise a wireless receiver not shown, and a wireless transmitter not shown.

The embodiments herein may be implemented through a processor or one or more processors, such as at least one processor 1140 of a processing circuitry in the network node 130 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the network node 130. One such carrier may be in the form of a CD ROM disc. It is however feasible with other data carriers such as a memory stick. The computer program code may furthermore be provided as pure program code on a server and downloaded to the network node 130.

The network node 130 may further comprise respective a memory 1150 comprising one or more memory units. The memory comprises instructions executable by the processor in the network node 130. The memory is arranged to be used to store instructions, data, configurations, and applications to perform the methods herein when being executed in the network node 130.

In some embodiments, a computer program 1160 comprises instructions, which when executed by the at least one processor, cause the at least one processor of the network node 130 to perform the actions above.

In some embodiments, a respective carrier 1170 comprises the respective computer program, wherein the carrier is one of an electronic signal, an optical signal, an electromagnetic signal, a magnetic signal, an electric signal, a radio signal, a microwave signal, or a computer-readable storage medium.

The network node 130 may further be configured to perform any one or more out of actions 701-703 in any suitable order, e.g., by used of the at least one processor 1140 and/or by use of a control unit, and/or by use of any other suitable means.

Those skilled in the art will also appreciate that the functional modules in the network node 130, described below may refer to a combination of analog and digital circuits, and/or one or more processors configured with software and/or firmware, e.g. stored in the network node 130, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### EXAMPLE EMBODIMENTS

Below, some example Embodiments 1-36 are shortly described. See e.g. FIGS. 3-9. These Embodiments 1-36 may be combined with the above actions in any suitable manner.

Embodiment 1. A method performed by a first User Equipment, UE, 121 e.g., for handling a Multicast Broadcast Service, MBS, session, in a wireless communications network 100, the method comprising any one or more out of:
receiving 501 a first indication as transmitted by a network node 110, the first indication being indicative of an activation time of the MBS session, e.g., a scheduled activation time or a tentative activation time of the MBS session, and wherein when the first UE 121 has not already joined the MBS session, and upon receiving 501 the first indication, triggering 502 the first UE 121 to join the MBS session before the indicated activation time,
receiving 503 a second indication as transmitted by the network node 110, the second indication being indicative of a time window before an activation time and/or start time of the MBS session, and upon receiving 503 the second indication, triggering 504 the first UE 121 to transition to a Radio Resource Control, RRC, Connected state, e.g., RRC_CONNECTED, by selecting a frame within the time window to use for a PRACH procedure,
when the first UE 121 has joined the MBS session, refraining 505 from initiating a power saving state, e.g., refraining from initiating Extended Discontinuous Reception, eDRX, and/or activating Mobile Initiated Connection Only, MICO, mode for the first UE 121.

Embodiment 2. The method according to Embodiment 1, further comprising:
transmitting 506 to a radio network node 110, e.g., a gNB, a third indication indicative of that the first UE 121 is waiting for multicast transmission to start in the MBS session.

Embodiment 3. The method according to Embodiment 2, wherein the transmitting 506 the third indication further comprises transmitting to the radio network node 110, a fourth indication indicative of a remaining time until a start time and/or activation time of the MBS session, e.g., as received in the first indication.

Embodiment 4. The method according to any one of Embodiments 1-3, wherein when the first UE 121 is configured with a power saving state, e.g., eDRX and/or MICO mode, triggering 507 the first UE 121 to start monitoring a Group Radio Network Temporary Identifier, G-RNTI, of the MBS session, e.g., at a start time and/or activation time of the MBS session, as indicated in the first indication. Embodiment 5. The method according to any one of Embodiments 1-4, further comprising triggering 509 the first UE 121 to leave the MBS session, and wherein when the first UE 121 leaves the MBS session, triggering the first UE 121 to transition back to an initial power saving configuration, e.g., an initial eDRX configuration and/or MICO mode.

Embodiment 6. The method according to Embodiment 5, wherein triggering the first UE 121 to transition back to an initial power saving configuration, e.g., an initial eDRX configuration and/or MICO mode, is performed based on whether the first UE 121 is active in any other MBS session.

Embodiment 7. The method according to any one of Embodiments 1-6, wherein the method further comprises receiving 508, as transmitted by the network node 130, one or more multicast transmissions on the MBS session, wherein the one or more multicast transmissions are arranged to be sent with a delay of at least a first time period after a start time and/or activation time of the MBS session, e.g., as received in the first indication.

Embodiment 8. The method according to any of Embodiments Embodiment 1-7, wherein the first and/or the second indication, is/are received 501, 503 as part of a service announcement message.

Embodiment 9. A method performed by a network node 130 e.g., an Application Server, AS, e.g., for handling a Multicast Broadcast Service, MBS, session, in a wireless communications network 100, the method comprising any one or more out of:
transmitting 601 towards a first User Equipment, UE, 121, a first indication indicative of an activation time of the MBS session, and wherein, when the first UE 121 has not already joined the MBS session, the first UE 121 is arranged to be triggered upon receiving the first indication, to join the MBS session before the indicated activation time,
transmitting 602 towards the first UE 121, a second indication indicative of a time window before an activation time and/or start time of the MBS session, and wherein the first UE 121 is arranged to be triggered upon receiving the second indication, to transition to a Radio Resource Control, RRC, Connected state, e.g., RRC_CONNECTED, by selecting a frame within the time window to use for a PRACH procedure,
transmitting 603 towards the first UE 121, one or more multicast transmissions on the MBS session, wherein the one or more multicast transmissions are arranged to be sent with a delay of at least a first time period after a start time and/or activation time of the MBS session, e.g., as transmitted in the first indication.

Embodiment 10. The method according to Embodiment 9, wherein the first and/or the second indication, is transmitted as part of a service announcement message.

Embodiment 11. The method according to any of Embodiments 9-10, wherein transmitting the first indication, the second indication, and/or the one or more multicast transmissions, is/are transmitted via a radio network node 110, which radio network node 110 is configured to forward the first indication, the second indication, and/or the one or more multicast transmissions to the first UE 121.

Embodiment 12. A method performed by a radio network node 110 e.g., a gNB, e.g., for handling a Multicast Broadcast Service, MBS, session, in a wireless communications network 100, the method comprising any one or more out of:
receiving 701 from the first UE 121, a third indication indicative of that the first UE 121 is waiting for multicast transmission to start in the MBS session, and
maintaining 702 a Radio Resource Control, RRC, connected state of the first UE 121 based on the third indication,
forwarding 703 from a network node 130 to the first UE 121, any one or more out of:
   a first indication of an activation time of the MBS session,
   a second indication indicative of a time window before an activation time, and/or start time of the MBS session, and
   one or more multicast transmissions.

Embodiment 13. The method according to Embodiment 12, wherein receiving 701 the third indication further comprises receiving from the first UE 121, a fourth indication indicative of a remaining time until a start time and/or activation time of the MBS session, e.g., as indicated by the first indication, and wherein maintaining 702 the RRC connected state of the first UE 121 is further based on the fourth indication.

Embodiment 14. The method according to Embodiment 13, wherein maintaining 702 the RRC connected state of the first UE 121 further comprises refraining from releasing the first UE 121 from the RRC connected state at least until the start time and/or activation time.

Embodiment 15. The method according to any of Embodiments 12-14, wherein maintaining 702 the RRC connected state of the first UE 121 is performed to ensure that the first UE 121 is not released to an RRC inactive or RRC idle state due to inactivity before multicast transmission in the MBS session has started.

Embodiment 16. A first User Equipment, UE, 121 e.g., configured to handle a Multicast Broadcast Service, MBS, session, in a wireless communications network 100, the first UE 121 being configured to any one or more out of:
receive a first indication as transmitted by a network node 130, the first indication being indicative of an activation time of the MBS session, e.g., a scheduled activation time or a tentative activation time of the MBS session, and wherein when the first UE 121 has not already joined the MBS session, and upon receiving the first indication, trigger the first UE 121 to join the MBS session before the indicated activation time,
receive a second indication as transmitted by the network node 130, the second indication being indicative of a time window before an activation time and/or start time of the MBS session, and upon receiving the second indication, trigger the first UE 121 to transition to a Radio Resource Control, RRC, Connected state, e.g., RRC_CONNECTED, by selecting a frame within the time window to use for a PRACH procedure, and
when the first UE 121 has joined the MBS session, refrain from initiating a power saving state, e.g., refraining from initiating Extended Discontinuous Reception, eDRX, and/or activating Mobile Initiated Connection Only, MICO, mode for the first UE 121.

Embodiment 17. The first UE 121 according to Embodiment 16, further configured to:
transmit to a radio network node 110, e.g., a gNB, a third indication indicative of that the first UE 121 is waiting for multicast transmission to start in the MBS session.

Embodiment 18. The first UE 121 according to Embodiment 17, wherein the first UE 121 is further configured to transmit to the radio network node 110, a fourth indication indicative of a remaining time until a start time and/or activation time of the MBS session, e.g., as received in the first indication.

Embodiment 19. The first UE 121 according to any one of Embodiments 16-18, wherein when the first UE 121 is configured with a power saving state, e.g., eDRX and/or MICO mode, trigger the first UE 121 to start monitoring a Group Radio Network Temporary Identifier, G-RNTI, of the MBS session, e.g., at a start time and/or activation time of the MBS session, as indicated in the first indication.

Embodiment 20. The first UE 121 according to any one of Embodiments 16-19, further configured to trigger the first UE 121 to leave the MBS session, and wherein when the first UE 121 leaves the MBS session, trigger the first UE 121 to transition back to an initial power saving configuration, e.g., an initial eDRX configuration and/or MICO mode.

Embodiment 21. The method according to Embodiment 20, wherein the first UE 121 is further configured to trigger the first UE 121 to transition back to an initial power saving configuration, e.g., an initial eDRX configuration and/or MICO mode, based on whether the first UE 121 is active in any other MBS session.

Embodiment 22. The first UE 121 according to any one of Embodiments 16-21, further configured to receive, as transmitted by the network node 130, one or more multicast transmissions on the MBS session, wherein the one or more multicast transmissions are arranged to be sent with a delay of at least a first time period after a start time and/or activation time of the MBS session, e.g., as received in the first indication.

Embodiment 23. The first UE 121 according to any of Embodiments 16-22, wherein the first and/or the second indication, is/are received as part of a service announcement message.

Embodiment 24. A network node 130 e.g., an Application Server, AS, e.g., configured to handle a Multicast Broadcast Service, MBS, session, in a wireless communications network 100, the network node 130 further being configured to any one or more out of:
transmit towards a first User Equipment, UE, 121, a first indication indicative of an activation time of the MBS session, and wherein, when the first UE 121 has not already joined the MBS session, the first UE 121 is arranged to be triggered upon receiving the first indication, to join the MBS session before the indicated activation time,
transmit towards the first UE 121, a second indication indicative of a time window before an activation time and/or start time of the MBS session, and wherein the first UE 121 is arranged to be triggered upon receiving the second indication, to transition to a Radio Resource Control, RRC, Connected state, e.g., RRC_CONNECTED, by selecting a frame within the time window to use for a PRACH procedure,
transmit towards the first UE 121, one or more multicast transmissions on the MBS session, wherein the one or more multicast transmissions are arranged to be sent with a delay of at least a first time period after a start time and/or activation time of the MBS session, e.g., as transmitted in the first indication.

Embodiment 25. The network node 130 according to Embodiment 24, wherein the first and/or the second indication, is transmitted as part of a service announcement message.

Embodiment 26. The network node 130 according to any of Embodiments 24-25, further configured to transmit the first indication, the second indication, and/or the one or more multicast transmissions, is/are via a radio network node 110, which radio network node 110 is configured to forward the first indication, the second indication, and/or the one or more multicast to the first UE 121.

Embodiment 27. The network node 130 according to any of Embodiments 24-26, further configured to maintain the RRC connected state of the first UE 121 to ensure that the first UE 121 is not released to an RRC inactive or RRC idle state due to inactivity before multicast transmission in the MBS session has started.

Embodiment 28. A radio network node 110 e.g., a gNB, e.g., configured to handle a Multicast Broadcast Service, MBS, session, in a wireless communications network 100, the radio network node 110 further being configured to any one or more out of:
receive from the first UE 121, a third indication indicative of that the first UE 121 is waiting for multicast transmission to start in the MBS session, and
maintain a Radio Resource Control, RRC, connected state of the first UE 121 based on the third indication
forward from a network node 130 to the first UE 121, any one or more out of:
   a first indication of an activation time of the MBS session,
   a second indication indicative of a time window before an activation time, and/or start time of the MBS session, and
   one or more multicast transmissions.

Embodiment 29. The radio network node 110 according to Embodiment 28, further configured to receive a fourth indication indicative of a remaining time until a start time and/or activation time of the MBS session, e.g., as indicated by the first indication, and to maintain the RRC connected state of the first UE 121 further based on the fourth indication.

Embodiment 30. The radio network node 110 according to Embodiment 29, further configured to maintain the RRC connected state of the first UE 121 by refraining from releasing the first UE 121 from the RRC connected state at least until the start time and/or activation time.

Embodiment 31. A computer program 960 comprising instructions, which when executed by a processor 940, causes the processor to perform actions according to any of the Embodiments 1-8.

Embodiment 32. A computer program 1060 comprising instructions, which when executed by a processor 1040, causes the processor to perform actions according to any of the Embodiments 9-11.

Embodiment 33. A computer program 1160 comprising instructions, which when executed by a processor 1140, causes the processor to perform actions according to any of the Embodiments 12-15.

Embodiment 34. A carrier 970 comprising the computer program 960 of Embodiment 31, wherein the carrier is one of an electronic signal, an optical signal, an electromagnetic signal, a magnetic signal, an electric signal, a radio signal, a microwave signal, or a computer-readable storage medium.

Embodiment 35. A carrier 1070 comprising the computer program 1060 of Embodiment 32, wherein the carrier is one of an electronic signal, an optical signal, an electromagnetic signal, a magnetic signal, an electric signal, a radio signal, a microwave signal, or a computer-readable storage medium.

Embodiment 36. A carrier 1170 comprising the computer program 1160 of Embodiment 33, wherein the carrier is one of an electronic signal, an optical signal, an electromagnetic signal, a magnetic signal, an electric signal, a radio signal, a microwave signal, or a computer-readable storage medium.

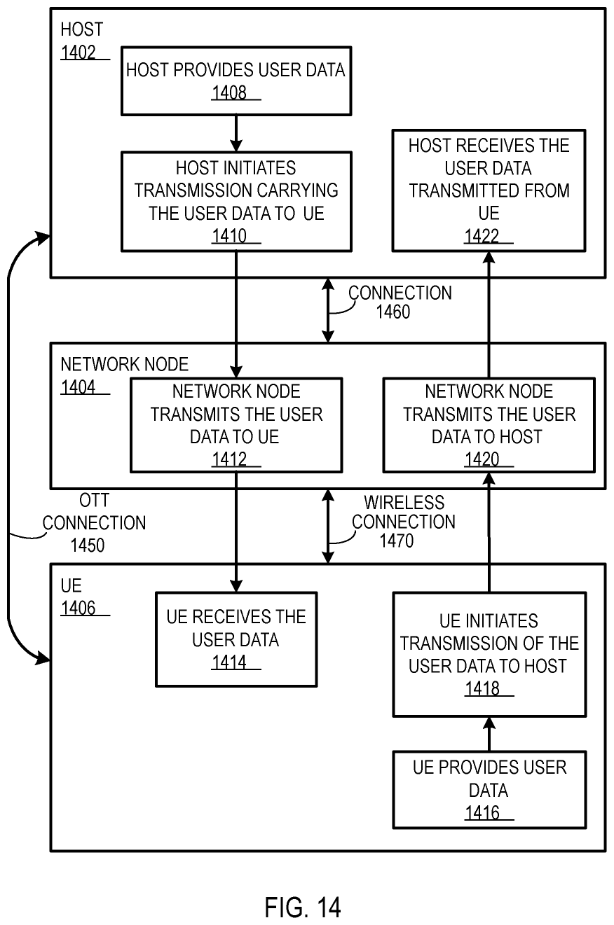

FIG. 12 shows an example of a communication system 1200 in accordance with some embodiments. The communication system 1200 may be the wireless communications network 100.

In the example, the communication system 1200 includes a telecommunication network 1202 that includes an access network 1204, such as a radio access network (RAN), and a core network 1206, which includes one or more core network nodes 1208, e.g., the network node 130. The access network 1204 includes one or more access network nodes, such as network nodes 1210a and 1210b, e.g., the radio network node 110, (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212), e.g., the first UE 121, and or any UE in the set of UEs 120, to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 1202.11 standards (Wi-Fi); and/or any other appropriate wireless communication standard, such as the Worldwide Interoperability for Microwave Access (WiMAX), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub-that is, a hub whose primary function is to route communications to/from the UEs from/to the network node 1210b. In other embodiments, the hub 1214 may be a non-dedicated hub-that is, a device which is capable of operating to route communications between the UEs and network node 1210b, but which is additionally capable of operating as a communication start and/or end point for certain data channels.

FIG. 13 is a block diagram of a host 1300, which may be an embodiment of the host 1216 of FIG. 12, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 shows a communication diagram of a host 1402 communicating via a network node 1404 with a UE 1406 over a partially wireless connection in accordance with some embodiments. Example implementations, in accordance with various embodiments, of the UE, network node (such as network node 1210a of FIG. 12), and host (such as host 1216 of FIG. 12 and/or host 1300 of FIG. 13) discussed in the preceding paragraphs will now be described with reference to FIG. 14.

Like host 900, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 1206 of FIG. 12) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1006 using the OTT connection 1050, in which the wireless connection 1070 forms the last segment. More precisely, the teachings of these embodiments may improve the power consumption and reduce traffic and thereby provide benefits such as reduced user waiting time, better responsiveness and extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1-48. (canceled)

49. A method performed by a first user equipment (UE) for handling a Multicast Broadcast Service (MBS) session, in a wireless communications network, the method comprising:
receiving a first indication from a radio network node, the first indication being indicative of an activation time of the MBS session;
receiving a second indication from the radio network node, the second indication being indicative of a time window before an activation time and/or start time of the MBS session;
after receiving the second indication, transitioning to a Radio Resource Control (RRC) Connected state, wherein transitioning to the RRC Connected state comprises selecting a frame within the time window to use for a Physical Random Access Channel (PRACH) procedure; and
transmitting, to the radio network node, a third indication indicative of that the first UE is waiting for multicast transmission to start in the MBS session.

50. The method of claim 49, wherein
the method further comprises, after receiving the first indication, joining the MBS session before the indicated activation time.

51. The method of claim 49, wherein
the method further comprises refraining from initiating a power saving state when joining the MBS session.

52. The method of claim 49, wherein
transmitting the third indication further comprises transmitting to the radio network node a fourth indication indicative of a remaining time until a start time and/or activation time of the MBS session.

53. The method of claim 49, wherein
the method further comprises monitoring a Group Radio Network Temporary Identifier of the MBS session.

54. The method of claim 49, wherein
the method further comprises triggering the first UE to leave the MBS session, and
the method further comprises triggering the first UE to transition back to an initial power saving configuration when the first UE leaves the MBS session.

55. The method of claim 54, wherein
triggering the first UE to transition back to the initial power saving configuration is performed based on whether the first UE is active in any other MBS session.

56. The method of claim 49, wherein
the method further comprises receiving one or more multicast transmissions on the MBS session, and
the one or more multicast transmissions are arranged to be received with a delay of at least a first time period after a start time and/or activation time of the MBS session.

57. The method of claim 49, wherein
the first and/or the second indication is/are received as part of a service announcement message.

58. A method performed by a radio network node for handling a Multicast Broadcast Service (MBS) session, the method comprising:
transmitting towards a first user equipment (UE) a first indication, the first indication being indicative of an activation time of the MBS session;
transmitting towards the first UE a second indication to trigger the first UE to transition to a Radio Resource Control (RRC) Connected state, the second indication being indicative of a time window before an activation time and/or start time of the MBS session; and
receiving from the UE a third indication indicative of that the first UE is waiting for multicast transmission to start in the MBS session.

59. The method of claim 58, wherein
the first indication is arranged to trigger the first UE to join the MBS session before the indicated activation time.

60. The method of claim 58, wherein
the method further comprises transmitting towards the first UE one or more multicast transmissions on the MBS session, wherein the one or more multicast transmissions are transmitted with a delay of at least a first time period after a start time and/or activation time of the MBS session.

61. The method of claim 58, wherein
the first and/or the second indication is transmitted as part of a service announcement message.

62. The method of claim 58, wherein
transmitting the first indication, the second indication, and/or the one or more multicast transmissions, is/are transmitted via a radio network node, which radio network node is configured to forward the first indication, the second indication, and/or the one or more multicast transmissions to the first UE.

63. A first user equipment (UE) configured to handle a Multicast Broadcast Service (MBS) session, the first UE comprising:
a transmitter;
a receiver for receiving from a radio network node i) a first indication being indicative of an activation time of the MBS session and ii) a second indication being indicative of a time window before an activation time and/or start time of the MBS session; and
processing circuitry, wherein the first UE is configured to:
transition to a Radio Resource Control (RRC) Connected state in response to receiving the second indication, wherein transitioning to the RRC Connected state comprises selecting a frame within the time window to use for a Physical Random Access Channel (PRACH) procedure; and
employ the transmitter to transmit to the radio network node a third indication indicative of that the UE is waiting for multicast transmission to start in the MBS session.

64. A radio network node configured to handle a Multicast Broadcast Service (MBS) session, the network node comprising:
a receiver;
a transmitter; and
processing circuitry, wherein the network node is configured to:
employ the transmitter to transmit towards a first user equipment (UE) a first indication indicative of an activation time of the MBS session and a second indication to trigger the first UE to transition to a Radio Resource Control (RRC) Connected state by selecting a frame within the time window to use for a Physical Random Access Channel (PRACH) procedure, the second indication being indicative of a time window before an activation time and/or start time of the MBS session; and
employ the receiver to receive a third indication transmitted by the UE, the third indication indicating that the first UE is waiting for multicast transmission to start in the MBS session.
